(19) United States
(12) Patent Application Publication
(10) Pub. No.: US 2021/0362561 A1
(43) Pub. Date: Nov. 25, 2021

(54) CASING INTENDED TO BE MOUNTED ON A MOTOR VEHICLE DOOR

(71) Applicant: Valeo Systemes Thermiques, le Mesnil-Saint-Denis (FR)

(72) Inventors: Thierry Petit, Le Mesnil Saint Denis (FR); Bruno Demory, Le Mesnil Saint Denis (FR); Yves Rousseau, Le Mesnil Saint Denis (FR)

(73) Assignee: Valeo Systemes Thermiques, Le Mesnil-Saint-Denis (FR)

(21) Appl. No.: 16/968,026

(22) PCT Filed: Feb. 6, 2019
(86) PCT No.: PCT/FR2019/050266

§ 371 Date: Aug. 6, 2020

(30) Foreign Application Priority Data
Feb. 8, 2018 (FR) 1851057

(51) Int. Cl. B60H 1/00; B60J 9/00; B60H 1/24

(52) U.S. Cl. CPC B60H 1/00564; B60H 1/243; B60J 9/00

(57) ABSTRACT

Casing (30) intended to be mounted on a motor vehicle door, the casing (30) comprises a first air inlet (35) for admitting a first air flow (FR) into the casing (30), an air outlet (36), a chamber delimited by at least one partition, arranged inside the casing (30), a second air inlet (39) for directly admitting a second air flow (FE) into the chamber.

The present invention relates to a housing intended to be mounted on a motor vehicle door. This device is part of an air distribution device for a vehicle of the motor vehicle type.

Generally, a motor vehicle is equipped with a heating, ventilation and/or air conditioning system that makes it possible to thermally treat the air and then send it into the passenger compartment of the vehicle. The heating, ventilation and/or air conditioning system is configured to reach a thermal comfort setpoint fulfilling a request from a user, and for example a given temperature of the air present in one zone or another of the passenger compartment of the vehicle. To do this, the heating, ventilation and/or air conditioning system draws in outside air and/or air from the passenger compartment and then treats it by passing it successively through heat exchangers in particular so that it reaches determined ventilation speed and/or temperature conditions that make it possible to approach the thermal comfort setpoint. The treated air is then projected into the passenger compartment by means of air vents disposed so as to supply a particular zone of the passenger compartment with treated air. Depending on whether it is desired to supply the front seats or the rear seats with treated air, these air vents may be disposed in the dashboard, the central console or the lateral uprights of the vehicle.

The heating, ventilation and/or air conditioning system is caused to treat a significant amount of air before reaching the thermal comfort setpoint. However, nowadays users require this thermal comfort setpoint to be reached more rapidly, without altering the quality of the air in the passenger compartment. Motor vehicle manufacturers and equipment fitters must then propose heating, ventilation and/or air conditioning systems that fulfill these requirements, without this generating excessively high costs, while still having a system that is compact, lightweight and easy to install. Another constraint is the standardization of vehicles, wherein the manufacturers have to be able to adapt to the needs of the consumer and to implement or not implement such a system depending on the wishes of the purchaser of the vehicle.

The aim of the present invention is therefore to provide a solution for improving both the distribution of the air and the thermal comfort in the passenger compartment, without oversizing the heating, ventilation and/or air conditioning system, which may be easily mounted or removed.

In this context, one subject of the invention is a housing, in particular a removable housing, intended to be mounted on a motor vehicle door comprising
a chamber, delimited by at least one wall, arranged inside the housing,
a first air inlet for directly admitting a first stream of air into the chamber,
a second air inlet for admitting a second stream of air into the housing,
an air outlet,

the second air inlet, the chamber and the air outlet being fluidically connected.

Thus, the invention allows the two streams of air to mix, this ensuring better blending of the air in the passenger compartment thus improving user comfort.

Specifically, by increasing the amount of blended air, the thermal mixing between the various streams of air takes place more rapidly. The housing corresponds to an element that can be gripped easily and that can be easily mounted on or removed from a vehicle door.

According to one or more features of the invention, which may be taken alone or in combination, it may be provided that:
the chamber comprises a blading extending inside the chamber;
the housing has a curved shape;
a duct is connected to the second air inlet for directly admitting the second stream of air into the chamber, the second stream of air coming from a heating, ventilation and/or air conditioning system;
the duct comprises bellows;
the chamber has an oblong-shaped section;
a channel for the at least partial flow of the first stream of air and the second stream of air extends from the first air inlet to the air outlet and is delimited by the walls of the housing and said at least one partition of the chamber;
the chamber opens into the channel via a contraction;
the housing comprises a first part, a chamber, corresponding to the delivery of the first stream of treated air coming from the heating, ventilation and/or air conditioning system, this chamber opening into a second part of the housing arranged outside the chamber via a contraction;
the contraction extends along the entire length of the chamber, in a direction followed by the stream of treated air into the mouth of the second air inlet or into the delivery duct connected to this second air inlet;
the housing comprises a mixing zone in which the second stream of treated air coming from the heating, ventilation and/or air conditioning system and the first stream of air from the passenger compartment are intended to mix by lapping the partition forming the chamber along a trajectory tangential to this partition.

The invention also relates to an assembly of a vehicle door comprising a support for a housing and of a housing as described above.

According to the invention the door comprises at least one trim panel and a door bodywork that together form the door.

Further features, details and advantages of the invention will emerge upon reading the description given below by way of indication with reference to drawings, in which:

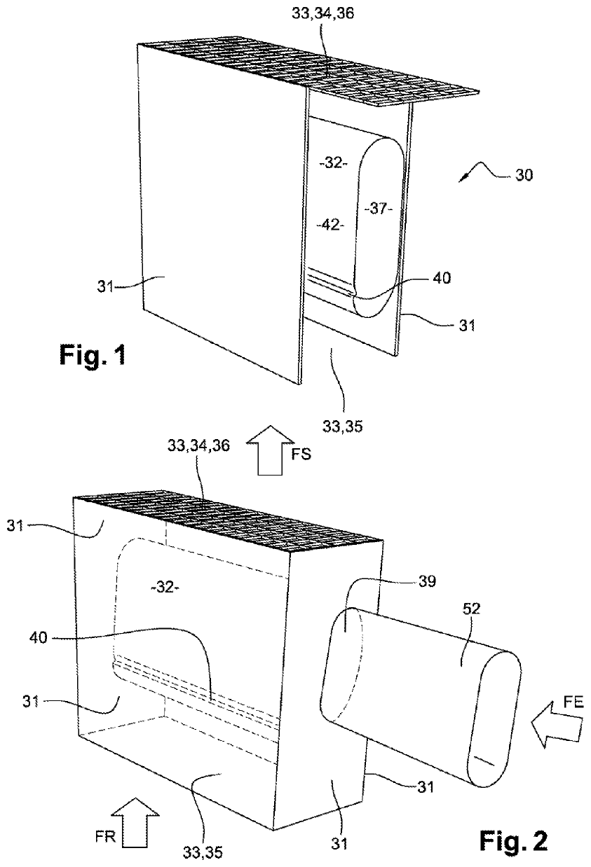

FIG. 1 is a perspective depiction of a part of the housing according to the invention,

FIG. 2 is a perspective depiction of the housing according to one embodiment according to the invention,

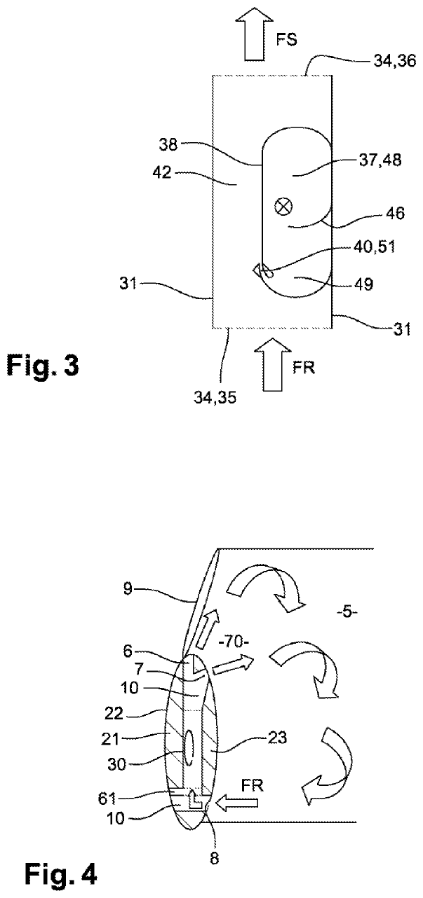

FIG. 3 is a schematic cross-sectional depiction of the housing according to the invention,

FIG. 4 is a schematic partial cross-sectional depiction of a motor vehicle passenger compartment and of a door of the vehicle comprising a housing according to an exemplary embodiment of the present invention,

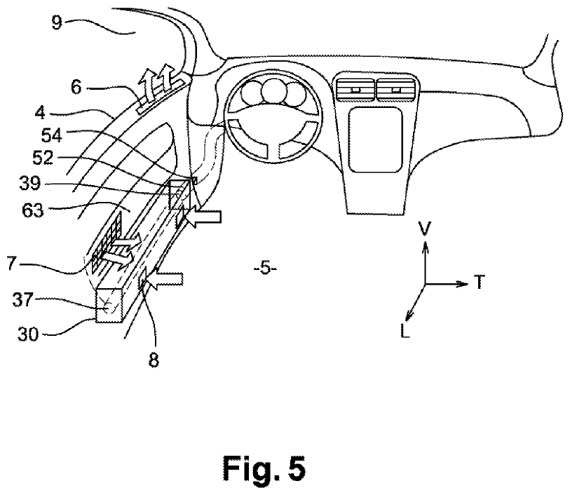

FIG. 5 is a schematic perspective depiction of a part of the passenger compartment of the motor vehicle and of the door comprising the housing.

It should first of all be noted that the figures set out the invention in a detailed manner in order to implement the invention, it being, of course, possible for said figures to serve to better define the invention if necessary.

In the following description, relative concepts such as “internal”, “external”, “upper”, “lower”, “front” or “rear” are defined with respect to a passenger compartment of the motor vehicle and to the vehicle itself. The concept of “internal” according to this frame of reference means that the element in question is situated or directed toward the passenger compartment, while the concept of “external” according to this frame of reference means that the element in question is situated or directed toward the outside of the motor vehicle, moving away from the passenger compartment. The concept of “upper” according to this frame of reference means that the element in question is situated or directed toward the roof of the motor vehicle, while the concept of “lower” according to this frame of reference means that the element in question is situated or directed toward the floor of the motor vehicle. A longitudinal axis L is defined as the axis along which the motor vehicle extends along its length, the longitudinal axis L being parallel to an axis of forward movement of the motor vehicle when the latter is running. In the following description, reference will also be made to an orientation as a function of a vertical axis V, defined as being the axis perpendicular to the floor of the vehicle when the latter is running, and of a transverse axis T, defined as being the axis perpendicular to both the longitudinal axis L and the transverse axis T. It will therefore be appreciated that the concepts of “internal” and “external” are understood along the transverse axis T, the concepts of “upper” and “lower” are understood along the vertical axis V and the concepts of “front” and “rear” are understood relative to the longitudinal axis L, the “front” of the vehicle being defined as the part of the vehicle in front of the driver under running conditions and the “rear” being the part situated behind the backrest of the driver's seat. The terms “upstream” and “downstream” are defined with respect to the flow of a stream of air.

FIGS. 1 and 2 illustrate a housing 30 according to the present invention. The housing is defined by a set of walls 31, in this case four, arranged so as to define an internal volume 32, or internal space. As illustrated in FIGS. 1 and 2, the housing 30 corresponds in this case to a rectangular parallelepiped with four contiguous walls 31 and the two other opposite faces 33 being open or being provided with a grille 34. In other words, the housing 30 therefore comprises four walls 31 that define an internal volume 32, or a cavity, the housing also comprises a first air inlet 35 for allowing a first stream of air FR to enter the housing 30 and an air outlet 36 for allowing a stream of air FS to leave the housing 30. The housing 30 thus comprises a channel 42 for the flow of the stream of air FR from the first air inlet 35 as far as the air outlet 36.

The housing 30 according to the invention also comprises a chamber 37, delimited by at least one partition 38, arranged inside the housing 30 in the internal volume 32. The housing 30 also comprises a second air inlet 39 for directly admitting a second stream of air FE into the chamber 37. The channel 42 corresponds to the internal volume 32 of the housing 30 situated outside the chamber 37, in other words the channel 42 is delimited by the walls 31 of the housing 30 and by said partition 38 of the chamber 37. The chamber 37 has at least one surface that coincides with a wall 31 of the housing 30, the second air inlet 39 being arranged on this surface.

The housing 30 according to the invention is arranged such that the first air inlet 35, the chamber 37 and the air outlet 36 are fluidically connected. In other words, the chamber 37 has an opening 40 arranged so as to allow the second stream of air FE to flow out of the chamber 37 and mix with the first stream of air FR in the internal volume 32 and the channel 42. In other words, the first stream of air FR enters the housing via the air inlet 35 and flows in the housing 30 in the direction of the air outlet 36, the second stream of air FE directly enters the chamber 37 and then flows through the opening 40 in the housing 32 in the channel 42. The chamber 37 opens into the channel 42 so as to allow the second stream of air FE to mix with the first stream of air FR. In other words, the housing 30 comprises a channel 42 for the flow of the first and second streams of air FE, FR and extends from the first air inlet 35 as far as the outlet 36 is delimited by the walls 31 of the housing 30 and said at least one partition 38 of the chamber 37.

According to the invention, the first stream of air FR may for example come from the passenger compartment of the vehicle while the second stream of air FE may for example come from a heating, ventilation and/or air conditioning system (not shown) situated upstream of the housing. In order to fulfill a request from a user regarding the thermal comfort setpoint of the passenger compartment 5, the temperature of the second stream of treated air FE may vary, in particular between hot, cold and temperate, as may the speed of the second stream of treated air FE by varying the speed of the fan of the heating, ventilation and/or air conditioning system. The housing 30 according to the invention allows the air in the passenger compartment 5 to mix with treated air coming from the heating, ventilation and/or air conditioning system, this ensuring better blending of the air in the passenger compartment thus improving user comfort, by ensuring the air in the passenger compartment is renewed and by reaching a thermal comfort setpoint more rapidly. Specifically, by increasing the amount of blended air, the thermal mixing between the various streams of air takes place more rapidly.

In order to allow better mixing between the two streams of air FE, FR, the chamber 37 the chamber comprises a blading 46 extending in its internal space. This blading 46 corresponds to an internal partition, in other words a rib, gutter, protuberance or protrusion, that extends partially inside the chamber 37. The blading 46 has the shape of a quarter of a circle and deviates the trajectory of the second stream of air FE thus inducing turbulence. The second stream of air FE enters the chamber 37 via the second air inlet 39 in the upper part 48 of the chamber 37 situated above the blading 46. Said stream of air FE is then oriented toward the opening 40 so as to be able to open into the channel 42, the opening being arranged in the lower part 49 of the chamber situated below the blading 46.

As illustrated in FIG. 3, the chamber 37 opens into the channel 42 via a contraction 51. In other words, the chamber 37 has an opening 40 allowing the second stream of air FE to flow from the chamber 37 into the channel 42. This opening 40, extending over the entire length of the partition 38, comprises a contraction 51 of the flow cross section so as to create a difference in pressure between the inside of the chamber 37 and the channel 42, outside the chamber 37. Given the pressure differential, the second stream of air FE situated inside the chamber 37 is therefore drawn in the direction of the contraction 51 then is propelled into the channel 42 where it is mixed with the first stream of air FR, and flows as far as the air outlet 36. In other words, the contraction 51 causes a reduction in the flow cross section that accelerates and increases the flow rate of the second stream of treated air FE coming from the heating, ventilation and/or air conditioning system, which then generates a drop in pressure liable to draw the first stream of air coming from the passenger compartment through the first air inlet 35.

As illustrated in FIG. 3, the chamber 37 has an oblong-shaped section. In other words, the chamber 37 has a section with a shape that is longer than it is wide and of which the corners are rounded. In other words, the planar transverse cross section of the chamber 37 is oblong-shaped. This shape, in combination with the angle at which the second stream of air FE leaves through the contraction 51, makes it possible to induce a Coand\check{a} effect, wherein the partition 38 of the chamber 37 corresponds to a Coand\check{a} surface at which the streams of air FE and FR are mutually deviated along this partition 38, in particular level with the planar surface and the convex surface (rounded edge), thus improving their mixing.

As illustrated in FIG. 2, the housing 30 comprises a duct 52 connected to the second air inlet 39 for directly admitting the second stream of air FE into the chamber 37. The duct 52 is for example connected to the heating, ventilation and/or air conditioning system of the vehicle, thus the second stream of air FE coming from the heating, ventilation and/or air conditioning system emerges directly into the chamber 37.

According to one embodiment, the duct 52 comprises bellows 54 as illustrated in FIG. 5. Specifically, the housing 30 is arranged so as to be mounted in a door 4. Now, the door will be caused to be opened and closed, so that by arranging a bellows 54, i.e. an element formed by a cavity made of flexible material able to expand in order to fill with air by suction and to empty by compression producing a jet of directed air, a good seal and the prevention of air stream losses are assured.

In order to adapt to the shape of the door, the housing 30 may have a straight or rectilinear shape, or a curved or bent shape.

FIG. 4 shows a motor vehicle passenger compartment 5 in which a housing 30 is incorporated in a door 4 of which the structure and the walls form a hollow body 10. The hollow body 1 comprises at least three mouths 6, 7, 8 opening into the passenger compartment 5.

FIG. 4 also shows that the door 2 comprises a door bodywork 22 in this case associated with a first trim panel 21 and a second trim panel 23 on the other side. The trim panels 21, 23 are arranged on either side of the housing 30. The trim panels 21, 23 and the door bodywork 22 form between them a hollow body 10, or a channel in which the housing 30 is arranged. The door bodywork 22 delimits the motor vehicle relative to the outside of the motor vehicle and has one face exposed to the outside of the motor vehicle and one face turned toward the hollow body 10. The door comprises a support means 61 for carrying the housing 30. The support means 61 may correspond to hooks, notches being arranged on the housing 31, a grating on which the housing 30 is placed. The housing 30 may also be held solely by the two trim panels 21, 23.

The trim panels 21, 23 and the door bodywork 22 are at least partially connected by walls extending transversely relative to these faces. More particularly, there are defined a first transverse wall supporting the hinge allowing the door 2 to move relative to the vehicle, and a second transverse wall comprising a system for locking the door 2. It will therefore be appreciated that the first transverse wall is situated at the front of the vehicle compared with the second transverse wall that is situated further back in the vehicle, according to the frame of reference defined above.

FIG. 4 makes it possible to distinguish, among the mouths 6, 7, 8 of the air distribution device employing a housing 30, a first outlet mouth 6 arranged at the bottom of the window 9, a second outlet mouth 7 arranged in the armrests 63 and a third inlet mouth 8 arranged in the footwell, or in the floor of the passenger compartment 5.

FIG. 5 shows that a plurality of outlet mouths 6, 7 opening into the hollow body 10 may be provided. Regarding the disposition of these outlet mouths 6, 7 relative to the door 2, a first outlet mouth 6 is disposed at the bottom of a window 9 and a second outlet mouth 7 is disposed in an elbow rest or armrest 63 in order to deliver a stream of air 70 emitted in the direction of the torso of a user of the vehicle.

In general, each outlet mouth 6,7 is situated in an upper part of the door 2 according to the frame of reference defined above. In other words, each outlet mouth 7 is situated closer to the roof than to the floor of the motor vehicle. The outlet mouths 6, 7 are not coaxial.

According to the invention, and as is illustrated by FIGS. 4 and 5, a third inlet mouth 8 is provided. This additional inlet mouth 8 corresponds to a porous wall also opening into the hollow body 10. More specifically, the additional inlet mouth 8 is disposed on the trim panel 23, such that a stream of air FR from the passenger compartment 5 is drawn into the hollow body 10, then enters the housing 30 through the first air inlet 35 of the housing 30 and then is mixed with the second stream of treated air FE in the channel 42. The stream of mixed air flows through the air outlet 36 of the housing 30 and is oriented through the hollow body toward the outlet mouths 6, 7.

The principle of the suction of a stream by the flow of another stream is called stream induction, the first stream of air FR coming from the passenger compartment then forming a stream induced by a drop in pressure of the second stream of air FE coming from the heating, ventilation and/or air conditioning system in the housing 30. The second stream of air FE and the first stream of air FR that have been mixed then form the stream of air FS that is emitted through the one or more outlet mouths 6, 7.

In order to ensure better blending of the mixing between the second stream of air coming from the HVAC and the first stream of air FR coming from the passenger compartment, the hollow body 10 may be equipped with a mixing channel arranged to collect these two streams downstream of the inlet mouth 8 and to guide them as far as the outlet mouths 6, 7, with, for example, one or more stream disruptors disposed in this mixing channel in order to optimize the mixing of the stream of air FE with the stream of air FR inside the hollow body 10.

The inlet mouth 8 is configured in terms of size, disposition or physical features such that the second stream of air FE entering the channel 42 of the housing cannot leave via the inlet mouth 8. The speed of the second stream of air FE entering the channel 42 may also participate in avoiding leaving via the inlet mouth 8.

Without departing from the scope of the invention, a plurality of inlet mouths 8 may be provided. It should be noted that the one or more inlet mouths 8 are situated in a lower part of the door 2. In other words, each inlet mouth 8 is situated closer to the floor than to the roof of the motor vehicle. More specifically, the one or more inlet mouths 8 are situated closer to the lower face of the door 2, or even beneath the armrests 63, than the housing 30 is. Thus, according to the frame of reference defined above, the one or more inlet mouths 8 are disposed beneath the housing 30 along the vertical axis V.

The inlet mouth 8 corresponds in this case to a porous wall able to allow a stream of air coming from the passenger compartment to pass through enter the hollow body 10 present in the door 4. The stream of air FR enters the housing 30, optionally by passing through the support 61, through the first air inlet 35.

The invention as has just been described is not limited to the means and configurations exclusively described for a particular exemplary embodiment, and also applies to all combinations of these means or configurations and to equivalents and to any combination of such means or configurations with the equivalents. Specifically, although the invention has been described and illustrated according to various embodiments in the context of a vehicle door, it goes without saying that other elements forming hollow bodies in the passenger compartment may be envisaged without this negatively affecting the invention.

In an embodiment that is not illustrated, at least one heat exchanger may be arranged in the housing 30. For example, an electric heating device, or electric air radiator, may be arranged inside the housing, said heating device comprising at least one heating element, such as a positive temperature coefficient (PTC) stone, disposed in a frame and able to allow a stream of air to pass through so as to heat the stream of air. This electric radiator may be arranged inside the housing level with the first air inlet 35 so as to heat the first stream of air FR. More specifically the heating device may be arranged downstream, relative to the first stream of air FR, of the first air inlet 35 and upstream, relative to the first stream of air FR, of the opening 40. According to another embodiment, the heating device may be arranged downstream, relative to a stream of air, of the opening 40. According to another embodiment, the heat exchanger may be arranged between the support 61 and the housing 30. According to another embodiment, the heat exchanger may be arranged between the support 61 and the housing 30. According to another embodiment, the heat exchanger may be arranged between the trim panels 21, 23 and the door bodywork 22 inside the hollow body 10 so as to heat the first stream of air FR and/or the second stream of air FE.

1. A housing configured to be mounted on a motor vehicle door comprising:
a first air inlet for admitting a first stream of air into the housing;
an air outlet;
a chamber, delimited by at least one partition, arranged inside the housing; and
a second air inlet for directly admitting a second stream of air into the chamber,
the first air inlet, the chamber and the air outlet being fluidically connected.

2. The housing as claimed in claim 1, wherein the chamber comprises a blading extending inside the chamber.

3. The housing as claimed in claim 1, wherein the housing has a curved shape.

4. The housing as claimed in claim 1, wherein a duct is connected to the second air inlet for directly admitting the second stream of air into the chamber, the second stream of air coming from a heating, ventilation and/or air conditioning system.

5. The housing as claimed in claim 4, wherein the duct comprises bellows.

6. The housing as claimed in claim 1, wherein the chamber has an oblong-shaped section.

7. The housing as claimed in claim 1, wherein a channel for the at least partial flow of the first stream of air and the second stream of air extends from the first air inlet to the air outlet and is delimited by the walls of the housing and said at least one partition of the chamber.

8. The housing as claimed in claim 7, wherein the chamber opens into the channel via a contraction.

9. An assembly of a vehicle door comprising:
a housing support; and
a housing comprising:
a first air inlet for admitting a first stream of air into the housing,
an air outlet,
a chamber, delimited by at least one partition, arranged inside the housing, and
a second air inlet for directly admitting a second stream of air into the chamber,
the first air inlet, the chamber and the air outlet being fluidically connected.

10. The assembly as claimed in claim 9, wherein the vehicle door comprises at least one trim panel and a door bodywork that together form the vehicle door.

11. A housing, comprising:
four walls that define an internal volume of the housing;
a first air inlet for admitting a first stream of air into the housing;
an air outlet;
a chamber, delimited by at least one partition, arranged inside the internal volume of the housing; and
a second air inlet for directly admitting a second stream of air into the chamber,
wherein the first air inlet, the chamber and the air outlet are fluidically connected so as to allow the second stream of air to flow out of the chamber and mix with the first stream of air in the internal volume, and
wherein the housing is configured to be mounted on a motor vehicle door.
